(19) United States
(12) Patent Application Publication
(10) Pub. No.: US 2026/0099821 A1
(43) Pub. Date: Apr. 9, 2026

(54) MANAGING ELECTRONIC CALENDARS USING GENERATIVE MODELS

(71) Applicant: GOOGLE LLC, Mountain View, CA (US)

(72) Inventors: Gabi Lanning, Austin, TX (US); Dmitrii Boiarshinov, Austin, TX (US); Jaime Guajardo, Austin, TX (US)

(21) Appl. No.: 18/911,086

(22) Filed: Oct. 9, 2024

(51) Int. Cl. G06Q 10/1093

(52) U.S. Cl. CPC G06Q 10/1093

(57) ABSTRACT

Implementations described herein relate to leveraging generative models to manage electronic calendars. In various implementations, one or more scheduling targets or constraints associated with a particular person, or with a group of people that includes the particular person, may be determined. In response to receiving a query determined to be relevant to an electronic calendar manipulable by the particular person, a calendar action prompt may be assembled to include data indicative of: the electronic calendar, and the one or more scheduling targets or constraints. The calendar action prompt may be processed using one or more generative models to generate calendar action output. The calendar action output may convey one or more calendar actions to be performed in furtherance of managing the electronic calendar to satisfy the one or more scheduling targets or constraints. In various implementations, one or more of the actions may be performed.

### BACKGROUND

A calendar application or other schedule management system often includes features that enable a person (“user”) to schedule events such as appointments or meetings, and to receive reminders for appointments, meetings, or other tasks. For example, the user can use the calendar application to create a calendar event, send an invite for a calendar event, accept an invite, modify a calendar entry, delete a calendar event, or add a meeting note. However, such conventional calendar application functionalities, while allowing users to track past and incoming meetings and to receive reminders for events, often require a series of manual inputs from the user and provide very limited assistance in helping users to prioritize tasks and improve efficiencies in handling tasks.

Machine learning models, including various generative models (e.g., single-modal and multimodal large language models, “LLMs”), have been developed in the field of artificial intelligence (Al) to process user input (e.g., typed input, audible input, etc.), thereby generating output that reflects content responsive to the user input. For example, a generative model can be trained and/or fine-tuned to process natural language input that is typed or spoken and transcribed, to generate model output reflecting content that is responsive to the typed input. For example, a generative model may be used to process the natural language input, “how to change DNS settings on Acme router,” to generate the natural language response, “First, type the router's IP address in a browser, the default IP address is 192.168.1.1. Then enter username and password, the defaults are admin and admin. Finally, select the advanced settings tab and find the DNS settings section.”

### SUMMARY

Given the generative and/or predictive capabilities of generative models, calendar application functionalities of a calendar application (or other information management systems) can be enhanced as described herein to address one or more issues described above, without requiring back-and-forth navigation and manual operations of the user within the calendar application. This avoids or reduces typing errors introduced by user input, saves time and costs associated with the manual operations, reduces the risk of having time conflicts when scheduling events, and helps users manage their time more efficiently, among other things.

Implementations disclosed herein relate to methods and systems for leveraging one or more machine learning (ML) models, e.g., generative model(s), in enhancing functionalities of a calendar application (or other information management systems). In various implementations, the calendar application can be installed at, or otherwise accessed via, a client device such as a cellphone, a laptop, a desktop, etc. In various implementations, a system can include the calendar application (or other information management system) and/or an automated assistant that accesses the one or more generative models. In various implementations, alternatively, the system may not include the automated assistant, and the calendar application can access the one or more generative models, respectively, e.g., via one or more calendar agents.

In some of the various implementations, the system can (but is not required to) determine a context that is associated with the calendar application and/or that is associated with a user of the calendar application. This context may include, for instance, one or more targets/goals and/or constraints associated with a particular person, or with a group of people that includes the particular person. In some of the various implementations, the context associated with the calendar application (and/or associated with the user of the calendar application) can be determined from user input. For example, a user interface (or a pop-up window) of an electronic calendar of the calendar application can include an input field to receive typed user input that describes a context (e.g., “I am a new manager, and I am struggling with meeting overload”). The input field can, but is not required to, include content, e.g., an instruction such as “please type in your role and how you feel about current calendar bookings”. The context can correspond to information indicating a role (e.g., “new manager”) of the user, and/or indicate an overall status (e.g., overload) of the electronic calendar.

As another example, the context can be determined based on calendar data (and/or metadata) associated with the electronic calendar and/or metadata associated with the user of the electronic calendar. The calendar data can indicate, for instance, the number of meetings (or other calendar events) and/or a total duration of the meetings of the user in the electronic calendar. The metadata associated with the user of the electronic calendar can indicate a role (e.g., a manager, a team member of a team, etc.) of the user. As a further example, the system can generate an audible request (e.g., “What's your role, and how do you feel with the calendar scheduling?”) seeking user input that describes the context associated with both the calendar application and the user of the calendar application. The user input can be, for instance, typed input, touch input, or audible input (e.g., “I am a new manager, and I am struggling with meeting overload”), etc.

In some of the various implementations, additionally, or alternatively, the system can determine (or receive) a calendar calibration request associated with the calendar application. In some implementations, the calendar calibration request can be a request that is determined from user input and that indicates one or more categories/types of calendar events (e.g., booked meetings with no agendas and/or pending calendar invites with no agendas) to be calibrated (e.g., modified, deleted, etc.). Additionally or alternatively, the calendar calibration request can indicate one or more categories/types of calendar events to be maintained, or added (e.g., repeated per week, every two or three weeks, per month, etc.). Additionally or alternatively, the calendar calibration request can indicate one or more categories/types of calendar invites to be declined, accepted, or modified. For example, content of the calendar calibration request can be processed to determine a user intent to automatically decline (or remove) all calendar invite(s) from unknown senders. In some implementations, the calendar calibration request may include data indicative of one or more targets (e.g., goals) and/or constraints associated with a particular person, or with a group of people that includes the particular person (e.g., an organization such as a company that employs the particular person).

In some implementations, the system can receive the calendar calibration request via an input field. For example, the system can render an additional input field via a user interface of an electronic calendar of the calendar application, seeking user input that describes the calendar calibration request. The additional input field can, but is not required to, include content, e.g., an instruction such as “please type in your goal of using the calendar application”. As another example, the system can generate an audible prompt (e.g., “what's your goal of using the calendar application?”) seeking user input that describes the calendar calibration request. As a non-limiting example, given user input of “I want to spend time in the meetings that will get my team the most visibility, but still need heads-down time to get my work done which I've been doing on the weekends”, the system can process content of the user input to determine that the user input includes a calendar calibration request that includes a first request to keep meetings with managers in an electronic calendar of the user (or to label these meetings with high importance, etc.) and a second request to create (or modify) calendar events (e.g., in a focused mode) for heads-down working hours during the week (to avoid working on the weekend). In some implementations, between the starting and ending time for a calendar event configured with a focused mode, the system can automatically mute any calendar invites, notifications and/or messages, to allow a user associated with the calendar event to focus on his or her work.

In various implementations, the system can determine whether the calendar calibration request is directed to a single electronic calendar (which may or may not be shared between multiple users) or is directed to a group of electronic calendars (e.g., each associated with a group member of a working group, a family group, etc.). In some of the various implementations, in response to determining that the calendar calibration request (e.g., “Find a time to add a weekly group meeting for everyone to attend in my group”) is directed to multiple electronic calendars, the system can further determine (or verify) whether the user that provides the calendar calibration request is authorized to access each of the multiple electronic calendars. In response to determining that the user that provides the calendar calibration request is authorized to access each of the multiple electronic calendars, the system can process calendar data associated with the multiple electronic calendars to perform one or more calendar actions for each of the multiple electronic calendars.

For instance, in the example where the calendar calibration request is “Find a time to add a weekly group meeting for everyone to attend in my group”, the system can process the calendar calibration request and/or the calendar data associated with the multiple electronic calendars, to determine a common time for everyone belonging to the user's group to attend group meeting(s), and add a calendar event (e.g., titled “group meeting”) in each of the multiple electronic calendars at the determined common time. Continuing with this example, in some implementations where no common time can be found for everyone within the group to attend, the system can determine, based on calendar data of the multiple electronic calendars, a time having the minimum number of time conflicts. The system can further determine electronic calendar(s) and calendar event(s) within those determined electronic calendar(s) that show time conflict(s), and generate one or more suggestions that suggest a change for each of the calendar event(s) that show time conflict(s). For example, if the system determines a time for group meeting that works for everyone but a first user and a second user, the system can identify a first calendar event in an electronic calendar of the first user that causes time conflict and identify a second calendar event in an electronic calendar of the second user that causes time conflict. The system can further suggest a first change to the first calendar event (e.g., move the first calendar event to another time slot in the electronic calendar of the first user) and suggest a second change to the second calendar event (e.g., shorten the second calendar event in the electronic calendar of the second user so that there is no longer any time conflict).

In some of the various implementations where the system determines that the calendar calibration request is directed to a single electronic calendar, the system can determine whether to apply the calendar calibration request to all calendar entries/events or a portion thereof. In some of the various implementations, the system can determine whether to apply the calendar calibration request to all incoming calendar invites (not received yet), or to apply the calendar calibration request to all pending calendar invites (received but not yet accepted or declined, etc.). In some of the various implementations, the system can identify one or more categories of calendar events (e.g., one or more calendar events created by the user herself, one or more calendar events created based on accepting calendar invite(s)) to be modified based on the calendar calibration request, and/or one or more pending calendar invites to be accepted, declined, or modified. In some of the various implementations, the system can modify (or delete) one or more existing calendar entries based on the calendar calibration request. In some of the various implementations, the system can determine, based on the calendar calibration request, whether to accept, decline, or propose an alternative for a pending calendar invite. In some implementations, a pending calendar invite may be displayed as a calendar event (e.g., a temporary calendar event) in an electronic calendar of a user who receives the pending calendar invite, but this is not required.

In some implementations, the system can automatically decline one or more calendar invites (e.g., a single calendar invite, recurring calendar invites) from one or more users that are not member(s) of a group that the user belongs (e.g., manages). In some implementations, the system can automatically decline meetings intended for entry-level employees based on a role of the user being a manager and based on the calendar calibration request indicating that the user wants to focus on meetings that could help the user (e.g., the manager) to enhance a visibility of his or her team. These examples are provided herein for illustrative purposes and are not intended to be limiting.

In some of the various implementations, the calendar calibration request can be generated based on user input identifying desired time slot(s) for one or more user activities (e.g., working, workout, having lunch, etc.). For example, the calendar calibration request from a user can identify a particular time slot (e.g., every Friday morning) as a focus time for working (or other user activity). In this case, the system can, for example, move an existing time slot booked in the focused mode (“do-not-disturb mode”) from Saturday afternoons to Friday mornings, based on the calendar calibration request.

In some of the various implementations, in response to receiving the calendar calibration request, the system can determine whether to generate one or more additional follow-up questions seeking further clarification to fulfill the calendar calibration request. For example, the calendar calibration request can be, for instance, “I want to spend more time attending meetings that help my team get more visibility, but also spend time organizing a focus group for my team”. In response to receiving such calendar calibration request, the system can perform one or more calendar actions (e.g., label or mark existing and incoming meetings with senior managers or client with high importance, and send message reminding the user for these meetings) based on a first portion (e.g., “I want to spend more time attending meetings that help my team get more visibility”) of the calendar calibration request. Additionally, or alternatively, the system can generate one or more additional questions such as “what time works best for you for the focus group, in the morning or in the afternoon?” based on a second portion of the calendar calibration request (“spend time organizing a focus group for my team”) lacking key information (e.g., a time) to perform a corresponding calendar action. In response to receiving user input such as “in the morning”, the system can search the electronic calendar of the user and electronic calendar(s) of other group member(s) to select a time slot that works for everyone.

In some implementations, the system can remind the user of a deadline (e.g., March 21^{th}) for a task (e.g., writing a report) described in a calendar event at a first time (e.g., March 19^{th}) prior to the deadline. In this case, the system can determine whether the task is fulfilled by the user at the first time. For instance, the system can determine that the task is fulfilled based on the user marking the task being completed on or before the first time, or based on the user sending electronic correspondence (e.g., email, text message) indicating that the task has been completed, explicitly (e.g., an email that says, “I've completed this task”) or implicitly (e.g., an email attaching work product that was the task's goal). If the system determines that the task is not fulfilled by the user at the first time, the system can automatically determine a particular time slot (e.g., 3-4pm on March 20^{th}) for the task before the deadline, create a calendar event for the user to work on the task in the focused mode during the particular time slot, and remind the user to fulfill the task during the determined particular time slot.

In various implementations, the system can generate one or more notifications or alerts, e.g., based on detecting an upcoming calendar event that is of a particular type. For example, given a calendar event identifying a task with a high priority level (e.g., meeting with VP), the system can generate and send a notification such as “looks like you have a meeting this week with VP, do you need me to give you more time to prepare?” If the user replies with “Yes”, the system can determine that a calendar calibration request of “give me more time to prepare for the meeting with VP this week” is received. Alternatively, the system may act automatically, e.g., without sending the user a notification. Based on the determined calendar calibration request and/or based on calendar data of the calendar events (e.g., a title or description of each calendar event, identities/roles of invitees), the system can move, modify, and/or remove one or more calendar events (e.g., movie night, etc.) from the electronic calendar of the user. In some implementations, the system can generate one or more notifications or one or more changes to an electronic calendar (e.g., send a message reminder to a phone of the user five minutes in advance, pop up a link for the user to attend a virtual meeting) based on detection of a pattern from historical user activities/actions (e.g., the user historically has been late to join meetings, e.g., late in clicking the link to attend the virtual meeting, and/or last minute cancelation of a meeting, etc.). In various implementations, these historical user activities/actions can be determined from logs of calendar interactions associated with calendars of individual users and/or calendars shared amongst multiple users.

In various implementations, the system can seek user permission to access one or more additional applications (e.g., web browser, social media platform, etc.) and/or one or more devices (e.g., IoT devices such as smart watch, smart fridge, etc.). The system can generate one or more notifications for one or more calendar events based on detecting one or more user activities with respect to the additional application(s) and/or the additional device(s). For example, the system can detect that the user has spent extensive time on a web browser application and correspondingly generate and render a notification such as “hmmm . . . it seems that you have a nice break, would you consider following up with the task (e.g., write a proposal, deadline: xx xx) in calendar item Y?” The notification can identify, for instance, one or more calendar events with high importance and with an approaching deadline. The notification can additionally, or alternatively, include a link to a calendar event and/or a link to a file (or email, message, etc.) associated with a task in the calendar event.

In various implementations, the system can generate one or more reports reporting user statistics associated with the electronic calendar (and/or other applications or devices) of the user. For example, the one or more user calendar reports can include a weekly report, a biweekly report, a monthly report, or a quarterly report, etc. A user calendar report can track the amount of time the user spent on different tasks that are identified in calendar events of the electronic calendar. Additionally, or alternatively, the user calendar report can include an indication about whether user activities associated with calendar events of the electronic calendar are aligned with the calendar calibration request.

The user statistics data can, for instance, indicate that, subsequent to receiving the calendar calibration request, the user still created or attended one or more meetings or accessed work projects/files on Saturdays or Sundays, which deviated from user-defined scheduling targets and/or constraints. In this case, the user calendar report can include a time-management tip suggesting one or more approaches for managing work in an efficient way. The user calendar report can, as another example, indicate that, subsequent to receiving the calendar calibration request where a manager desires higher visibility for the team she manages, the user statistics associated with the electronic calendar indicate that the manager is still spending too much time meeting with peers and reviewing internal reports. In this case, the user calendar report can include one or more suggestions, such as reducing the frequency of meetings with peers, grouping one or more meetings together, or freeing up more leisure time to meet with leadership, etc. In some implementations, the system can determine the user statistic data based on calendar data (and/or metadata) of the electronic calendar, and/or metadata associated with other applications or devices which includes but is limited to screen time report(s).

The user calendar report can be, for instance, “Over the last month, you spent 38% of your time in heads down work, with 25% scheduled for a specific task and the remaining 13% for personal or non-work needs like social media. You spent 62% of your time in meetings with, 22% of those meetings with people more senior than you and 40% at your level or lower. Want to try and improve senior management visibility more?”

In various implementations, responsive content (e.g., user calendar report, one or more suggestions, etc.) generated in response to the calendar calibration request can be determined using one or more machine learning (ML) models (e.g., generative model(s)). In some implementations, calendar actions (e.g., modifying a particular type of calendar invites, automatically declining a particular type of calendar invites, recommending calendar modifications) can be determined using the one or more machine learning models. In some implementations, one or more prompts can be generated based on content of the calendar calibration request and/or calendar data associated with one or more electronic calendars identified based on the calendar calibration request. In some implementations, the one or more prompts can be processed, respectively, using a plurality of generative models, to generate a plurality of model outputs. The aforementioned responsive content and/or calendar actions can be determined from the plurality of model outputs.

In some implementations, in response to receiving the calendar calibration request, a subset of ML models can be selected from a plurality of ML models to which the calendar application has access. For each ML model from the selected subset, a respective prompt can be generated, e.g., by an agent with access to the respective ML model. For example, for a first ML model from the selected subset of ML models, a first prompt can be generated based on content of the calendar calibration request and based on a first subset of calendar data associated with an electronic calendar that is identified based on the calendar calibration request. For a second ML model from the selected subset of ML models, a second prompt can be generated based on content of the calendar calibration request and based on a second subset of calendar data associated with the electronic calendar identified based on the calendar calibration request. In some implementations, the first prompt can be processed as input, e.g., by a first agent using the first ML model to generate one or more first model outputs. In some implementations, the second prompt can be processed as input, e.g., by a second agent using the second ML model, to generate one or more second model outputs. The aforementioned responsive content and/or calendar actions can be determined from the one or more first model outputs and the one or more second model outputs. For example, the first and second agents may return their respective model outputs to an “orchestration agent” that triggered the first and second agents. More details about the utilization of ML models in fulfilling the calendar calibration request can be found elsewhere in this disclosure, and descriptions herein are not intended to be limiting.

By implementing one or more aspects of the various implementations described above and elsewhere in this disclosure, the calendar application can be enhanced with capabilities in calibrating one or more electronic calendars to automatically track time, to propose changes to the electronic calendar(s), to prioritize deadlines, or to help one or more users in preparing for event(s), etc. This obviates the time and efforts a user will have otherwise to spend in manually combing through calendar events for meetings over several weeks and categorizing those meetings into different types, in order to track time the user has spent during the past weeks. Further, some of the various implementations disclosed herein make it possible to automatically calibrate one or more electronic calendars (e.g., modifying multiple calendar events to reduce meeting duration by half, deleting calendar events having no agenda or are proposed by unknown organizers) for the user to prioritize certain tasks or deadlines, thereby meeting one or more specific goals of the user.

Additionally, some of the various implementations disclosed herein ensure that a user has access to any linked documents in a meeting invite and that the user has sufficient time to pre-read the linked documents to prepare for the invited meeting. Some of the various implementations disclosed herein further space out meetings vs. working time. Some of the various implementations may cause one or more calendar actions to be performed via the calendar application and/or cause one or more IoT devices to perform one or more third-party actions, to facilitate a user request received via the calendar application. Some of the various implementations may determine whether meetings or other events in an electronic calendar of a user are scheduled in a manner that allows the user to efficiently spend his or her time. For example, some of the various implementations can analyze a log of calendar interactions (or a single person or multiple people of an organization), e.g., using a generative model, to generate a report indicating detection of any “ineffective” patterns (last minute meeting scheduled, sporadic meetings at random times rather than in a contiguous block of time) of productivity for the user (and/or other members of the organization). In addition to the report, some of the various implementations can suggest one or more changes to the electronic calendar, e.g., suggest creating office hours that one or more group members can book in a certain time slot.

In various implementations, a method implemented using one or more processors is provided. The method includes: receiving, from a user and via a client device of the user, a user input directed to a calendar application accessible at the client device. In response to receiving the user input directed to the calendar application, the method can further include: selecting a subset of machine learning models from a plurality of machine learning models associated with the calendar application; retrieving, for each machine learning model from the subset of machine learning models, a distinct subset of calendar data associated with an electronic calendar that the user accesses via the calendar application; generating, for each machine learning model from the subset of machine learning models, a distinct prompt based on the content of the user input and the distinct subset of calendar data; processing each distinct prompt, using a corresponding machine learning model from the subset of machine learning models, to generate a distinct model output; generating content based on the distinct model outputs respectively generated based on processing each distinct prompt; and causing the generated content to be rendered via the calendar application.

In some of the various implementations, optionally, the user input includes a first request to manage one or more pending calendar invites, and the subset of machine learning models includes a first machine learning model trained to determine whether to accept or reject calendar invites. In some of the various implementations, retrieving, for each machine learning model from the subset, the distinct subset of calendar data can include: retrieving a first subset of calendar data associated with the one or more pending calendar invites.

In some of the various implementations, additionally, or alternatively, the user input includes a second request to calibrate the electronic calendar or a portion of the electronic calendar. In some of the various implementations, the subset of machine learning models include a second machine learning model trained to modify calendar events. In some of the various implementations, the method further includes: determining one or more calendar actions based on the distinct model outputs respectively generated based on processing each distinct prompt, and causing the one or more calendar actions to be performed.

In some of the various implementations, the subset of machine learning models include a first machine learning model and a second machine learning model different from the first machine learning model. In this case, retrieving, for each machine learning model from the subset, the distinct subset of calendar data associated with the respective electronic calendar from the multiple electronic calendars can include: retrieving a first subset of calendar data for the first machine learning model, and retrieving a second subset of calendar data for the second machine learning model, where the first subset of calendar data is different from the second subset of calendar data.

The preceding is presented as an overview of only some implementations disclosed herein. These and other implementations are disclosed in additional detail later in this disclosure. For example, in some implementations, the calendar calibration request can include a request to validate meetings within the next month. In response to receiving such calendar calibration request, some of the various implementations can determine whether a user of the request has access to any linked file in a meeting invite and whether the user has sufficient time to prepare for a meeting requiring input from the user. For example, the system disclosed herein can validate each meeting event to determine whether the user has access to any linked file included in the meeting events, and in response to determining that the user has no access to a particular file, the system can automatically send a request that requests access to the particular file (without any user operation/action to manually formulate and send the request). Additionally, in response to determining that the user has insufficient time (e.g., less than four hours) to prepare for a particular meeting, the system can, for instance, move one or more calendar events (e.g., a meeting not requiring mandatory attendance) that have been booked to occur in the next four hours to a different date and/or time.

Various implementations can include a transitory or non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2A schematically illustrates an example of how various components described herein may cooperate to carry out selected aspects of the present disclosure.

FIG. 2B schematically illustrates another example of how various components described herein may cooperate to carry out selected aspects of the present disclosure.

FIG. 3A illustrates an example of a prompt generated in response to a user query from a user that is directed to an electronic calendar of the user, in accordance with various implementations of the present disclosure.

FIG. 3B illustrates the electronic calendar in FIG. 3A which is calibrated in response to the user query, in accordance with various implementations of the present disclosure.

FIG. 4 depicts an example of multiple prompts generated in response to a user query from a user that is directed to multiple electronic calendars associated with users within a group that the user manages, in accordance with various implementations of the present disclosure.

FIG. 5 depicts an example method of practicing selected aspects of the present disclosure, in accordance with various implementations.

FIG. 6 depicts another example method of practicing selected aspects of the present disclosure, in accordance with various implementations.

FIG. 7 depicts an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

A user can access a calendar application for one or more electronic calendars to plan (or track) events or tasks. The calendar application also allows the user to send and/or receive calendar invites. However, as the number of calendar events grows in an electronic calendar, it becomes harder for a user of the electronic calendar to track his or her time spent attending or completing the calendar events. For example, an executive may have a busy calendar and wants to know how much time is spent attending meetings, how much time is spent exercising, and how much time is spent traveling for work. In this example, the executive may need to calculate the allocation of time for different activities (e.g., meetings, exercise, business traveling, etc.) manually based on reviewing each calendar event/item of corresponding electronic calendar(s). Manually combing through calendar events for meetings over several weeks and/or categorizing those meetings into different types can be tedious, time-consuming, and error-prone.

By implementing techniques described herein to leverage AI, however, content and/or metadata associated with each calendar event of an electronic calendar (or more than one electronic calendar) can be processed, e.g., using a machine learning model such as a generative model, to generate model output(s) indicating time allocation for different activities and/or other information. In some implementations, as described below or elsewhere of this disclosure, additionally or alternatively, the model output(s) can indicate one or more calendar actions to be performed, one or more recommendations suggesting one or more changes to the electronic calendar(s), etc. This not only saves time and labor of the user, but also reduces or avoids the risk of organizing events that raise issues of time conflict, etc.

When a user of a calendar application receives calendar invites for meetings and other user activities, the user may need to manually review content of each calendar invite and determine whether or not to accept or reject each calendar invite based on the manual review. This can be time-consuming if the number of calendar invites the user receives is higher than usual. For example, given a large amount of calendar invites (e.g., all for the same week), the user may be unable to efficiently select and schedule calendar event(s), as the user may find conflicts in time, miss reading important information contained in one or more calendar invites, and/or not knowing a sender or other receiver(s) of one or more calendar invites.

By implementing techniques described herein to leverage Al, however, content and/or metadata associated with each calendar invite can be processed, e.g., using a machine learning model (such as a generative model), to generate model output(s) reflecting a suggestion as to whether or not to accept or reject a corresponding calendar invite. The model output(s) can, additionally, or alternatively, reflect natural language content indicating a reason to accept or reject the corresponding calendar invite. The model output(s) can, additionally, or alternatively, reflect additional natural language content indicating a reply to a sender of the corresponding calendar invite.

A user of a calendar application can modify a calendar invite, e.g., to change a starting time and/or an ending time, to move it to another date, etc. However, if the user wants to modify a plurality of upcoming calendar events in align with a calendar calibration/management goal (e.g., reduce the meetings with group members, increase meetings with directors, etc.), the user needs to manually check all upcoming calendar events one by one, identify a portion of the upcoming calendar events that need to be modified, and manually modify the identified portion of the upcoming calendar events. This results in intensive labor, costs a lot of time, and can lead to errors when modifying one or more calendar events.

By implementing techniques described herein to leverage AI, however, content and/or metadata associated with each calendar event can be processed, e.g., using a machine learning model (such as a generative model), to generate one or more model outputs indicating a selection of calendar events that need to be modified. Additionally, or alternatively, the one or more model outputs can be further processed to show modifications to the selection of calendar events. Advantages of the techniques described herein and elsewhere of this specification, however, are not limited thereto.

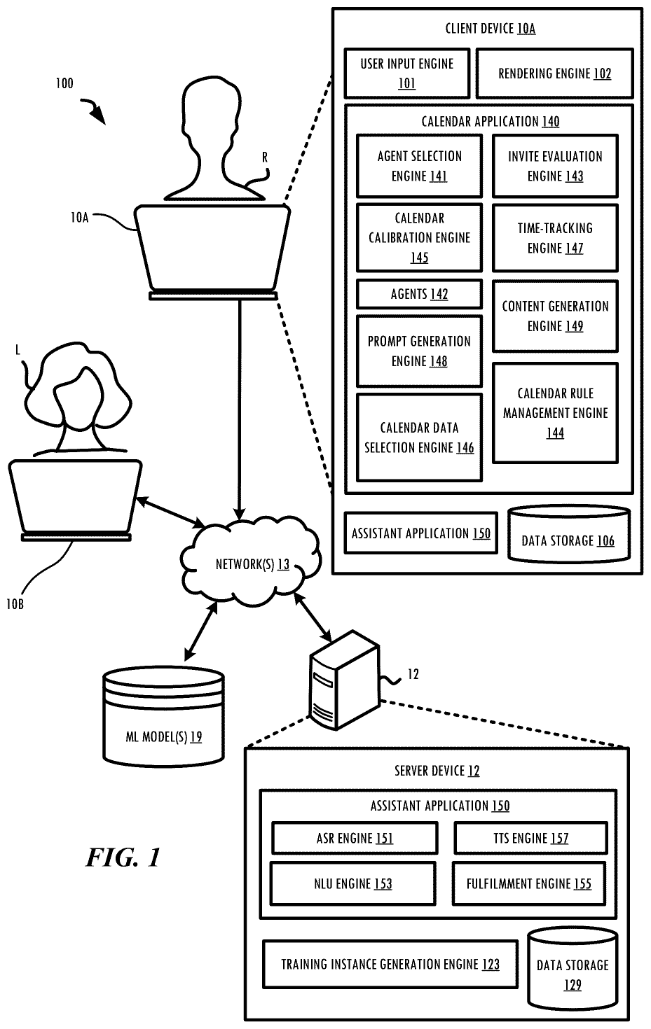

FIG. 1 is a block diagram of an example environment 100 that demonstrates various aspects of the present disclosure, and in which implementations disclosed herein may be implemented. As shown in FIG. 1, the environment 100 can include a first client computing device 10A (“first client device”) that is in communication with a server computing device 12 (“server device”). The client computing device 10A can be in communication with the server computing device 12, via one or more networks 13. The one or more networks 13 can include, for example, a local area network (LAN), a wide area network (WAN) such as the Internet, and/or any other appropriate network(s). In some implementations, the client computing device 10A (and/or the server computing device 12) can have access to one or more machine learning (ML) models 19, e.g., via the one or more networks 13. In some implementations, the example environment 100 can, additionally, or alternatively, include a second client computing device 10B that is in communication with the server computing device 12 and/or the first client computing device 10A. The second client computing device 10B can be of the same type, or of a different type, with respect to the first client computing device 10A. In some implementations, descriptions of the first client computing device 10A are applicable to the second client computing device 10B, and repeated descriptions are omitted for the sake of brevity.

In some implementations, the environment 100 can be an office environment, a home environment, a lab environment, or any other applicable environment, and the environment 100 can include additional client device(s) (or additional server device(s)) that connect to the one or more networks 13. In some implementations, the first client computing device 10A (or the second computing device 10B) can be, for example, a desktop computing device, a laptop computing device, a tablet computing device, a mobile phone computing device, a computing device of a vehicle (e.g., an in-vehicle entertainment system), a smart appliance (e.g., an interactive speaker), and/or a wearable apparatus that includes a computing device (e.g., glasses having a computing device, a smart watch, a virtual or augmented reality computing device), and the present disclosure is not limited thereto.

In various implementations, the first client computing device 10A (or 10B) can include a user input engine 101 that is configured to detect user input provided by a user (e.g., user R or user L) of the first client computing device 10A (or 10B). The user input may be provided by the user using one or more user interface input devices, such as a keyboard, a touch screen, a microphone, etc. The user input can be typed input, touch input, audible input, or any other applicable type of input. For example, the first client computing device 10A can be equipped with a keyboard to receive typed input, and/or a mouse (or one or more hardware buttons) to receive a user click that selects one or more graphical user interface (GUI) elements that is rendered visually at a user interface of the first client computing device 10A. The typed input (e.g., “optimize my calendar to reduce meetings and increase heads-down time”) can be received, for instance, via an input field of a graphical user interface (GUI) of an application (e.g., the calendar application 140, or an assistant application 150 that access the calendar application, etc.).

Additionally, or alternatively, the first client computing device 10A can be equipped with one or more microphones that capture audio data, such as audio data capturing spoken utterances of the user and/or other sounds in a surrounding environment of the first client computing device 10A. Optionally, the audio data capturing the spoken utterances can be received in response to a user selecting an icon indicating capturing/recording of audio data. The audio data may be subjected to speech-to-text (STT) processing to generate natural language text, or in some cases, the audio data may be processed using a ML model trained to map audio speech data directly to responsive content, without performing STT processing.

Additionally, or alternatively, the first client computing device 10A can be equipped with one or more vision components that are configured to capture vision data corresponding to images and/or movements (e.g., gestures) detected in a field of view of one or more of the vision components. Additionally, or alternatively, the first client computing device 10A can be equipped with one or more touch sensitive components (e.g., a stylus, a touch screen, a touch panel, etc.) that are configured to capture signal(s) corresponding to touch input that is directed to the first client computing device 10A.

In various implementations, the first client computing device 10A can include a rendering engine 102, and/or a data storage 106. In various implementations, the rendering engine 102 can be configured to provide content for audible and/or visual presentation to a user of the first client computing device 10A using one or more user interface output devices. For example, the first client computing device 10A can be equipped with one or more speakers that enable content (e.g., a notification sound) to be provided for audible presentation to the user via the first client computing device 10A. Additionally, or alternatively, the first client computing device 10A can be equipped with a display or projector that enables content (e.g., “You just receive a calendar invite for a meeting discussing the topic of IP protection during product development, we've highlighted this event based on the sender of the meeting being the VP and here are some links (link 1, link 2, link 3) to files and websites in the topic to help you prepare for the meeting”) to be provided for visual presentation to the user via the first client computing device 10A.

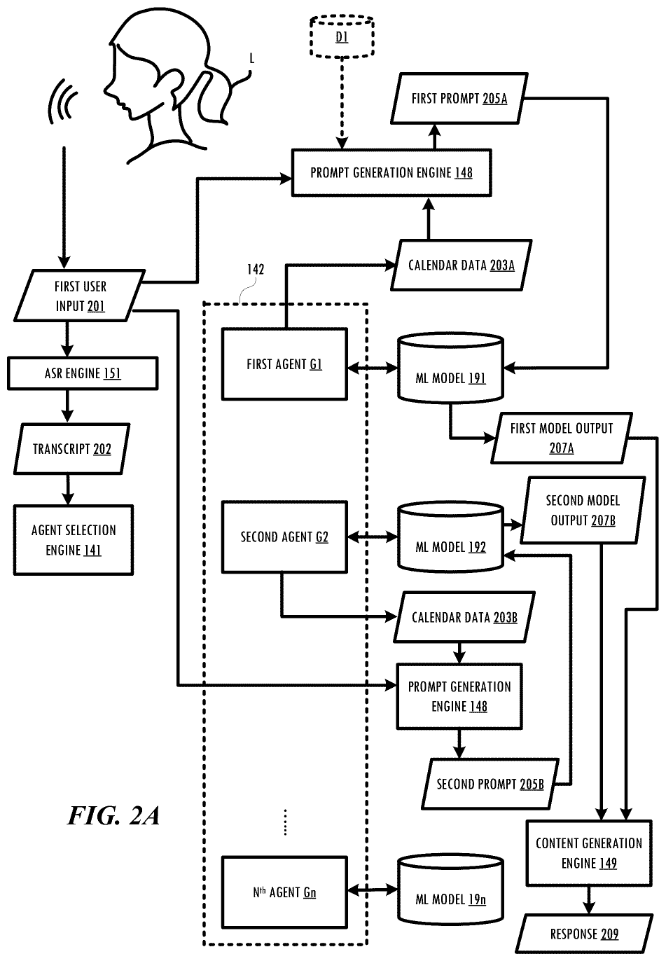

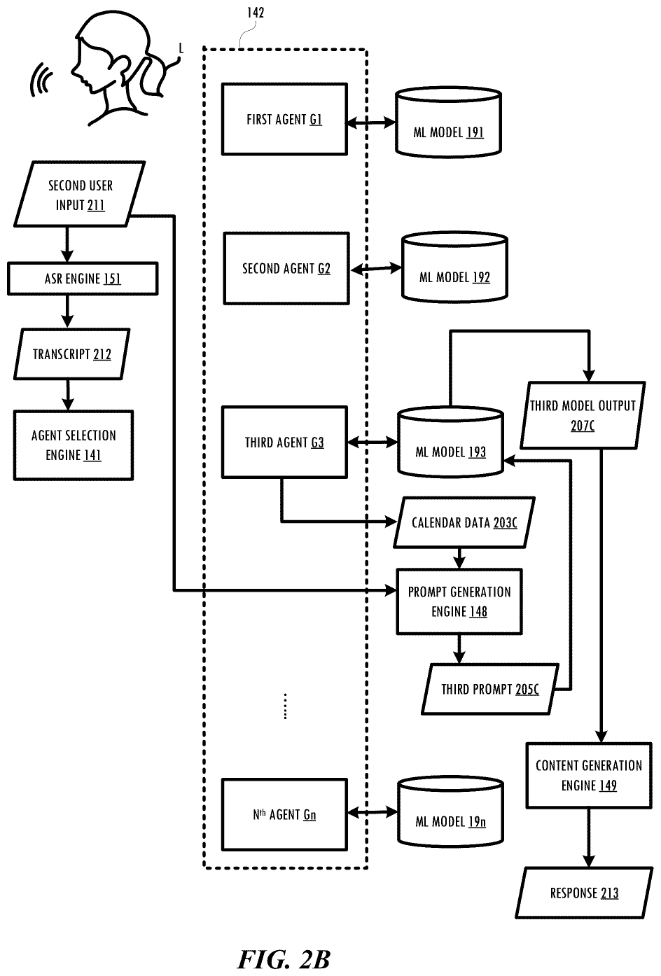

The data storage 106, and/or a data storage 129 at the server device 12, can store various types of files, folders, and/or other data. For instance, the data storage 106 of the first client computing device 10A can store metadata associated with the first client computing device 10A (or the second client computing device 10B), associated with the user (e.g., a user profile of user R, user L, etc.), and/or associated with one or more applications stored at or accessible via the first client computing device 10A (e.g., user activities with respect to a file application). Additionally, or alternatively, in some implementations, the data storage 106 (or the data storage 129) can store a plurality of training instances to train or fine-tune one or more of the ML models 19. In some implementations, the ML model(s) 19 can include multiple ML models, such as the first ML model 191, a second ML model 192, . . . , and/or an n^{th} ML model 19n depicted in FIG. 2A. The total number of the ML models 19, however, is not limited thereto. For example, the total number of the ML models 19 can be one, two, three, four, or more. The first ML model 191 (or other ML model(s)) can be a generative model such as an LLM, VLM, VQA model, diffusion model, etc.

In various implementations, the aforementioned one or more applications accessible via the first client computing device 10A (or 10B) can include a calendar application 140 that enables users to receive calendar invite(s), add an event to an electronic calendar, modify (e.g., move or delete) one or more events via the electronic calendar, receive reminder(s) for calendar event(s), and/or receive one or more reports showing user statistics (e.g., amount of time spent on attending meetings, etc.) associated with the electronic calendar. The features and functions of the calendar application 140, however, are not limited to descriptions herein. For example, in some implementations, the calendar application 140 can include additional functions, e.g., that enable a user to create calendar events (send calendar invite, etc.) using external tools or services (e.g., APIs for email, messaging application, social media application, etc.).

In various implementations, the aforementioned one or more applications accessible via the first client computing device 10A (or 10B) can include an assistant application 150. In some implementations, the assistant application 150 can be included in, or accessed by, the calendar application 140. In some implementations, the assistant application 150 can be an application that is separate from the calendar application 140. In this case, the assistant application 150 can access the calendar application 140 and/or other applications such as a social media application, a health management application, a music application, a shopping application, etc. In some implementations, the assistant application 150 (or the calendar application 140) can access one or more of the aforementioned ML models 19. For example, the assistant application 150 may be powered by one or more generative models.

In some implementations, the calendar application 140 (and/or the assistant application 150) can be installed locally at the first client computing device 10A (or 10B), and the user can access the calendar application 140 and/or the assistant application 150 via the first client computing device 10A. In some implementations, additionally, or alternatively, a user can access the calendar application 140 and/or the assistant application 150 via one or more websites. In some implementations, additionally, or alternatively, a user can access the calendar application 140 and/or the assistant application 150 via one or more third-party applications. The third-party application can be, for instance, a messaging application.

In various implementations, the calendar application 140 and/or the assistant application 150 can include, or otherwise access, an agent selection engine 141, an invite evaluation engine 143, a calendar calibration engine 145, a time-tracking engine 147, a content generation engine 149, and/or one or more agents 142. In some implementations, optionally, the calendar application 140 can include, or access, a calendar rule management engine 144, a calendar data selection engine 146, and/or a prompt-generating engine 148. In some implementations, one or more of components 141-149 can be accessed at and/or be hosted by the server computing device 12. In some implementations, additionally, or alternatively, the agent selection engine 141, the calendar invite management engine 143, the calendar calibration engine 145, the time-tracking engine 147, and/or the content generation engine 149 can be accessed at the first client computing device 10A (or the second client computing device 10B, etc.). In some implementations, optionally, the calendar application 140 and/or the assistant application 150 can include a plurality of agents G1, G2, . . . , Gn (e.g., calendar agents such as re-scheduling agent, see FIG. 2A) each including or having access to one or more of the ML models 19.

In some implementations, the agent selection engine 141 can, in response to a user input (e.g., a calendar calibration request received via a user interface of the calendar application 140, or received via the assistant application 150), select a subset of agents (e.g., G1 and G2) from the plurality of agents G1, G2, . . . , Gn. The agent selection engine 141 can select the subset of agents (e.g., G1 and G2) from the plurality of agents G1, G2, . . . , Gn, for instance, based on content of the user input and/or based on responsive content generated by processing the user input using one or more ML models 19.

Based on the selected subset of agents, the calendar data selection engine 146 can select and retrieve one or more subsets of calendar data associated with an electronic calendar for a user of the user input. The electronic calendar is accessible via the calendar application 140. Each of the one or more subsets of the calendar data can be respectively selected or retrieved based on a corresponding agent from the selected subset of agents.

In some implementations, during an initial iteration of a generative model, an orchestration agent (e.g., G1, which in some cases may include the agent selection engine 141 and/or prompt generation engine 148) may assemble a calendar action prompt that includes data indicative of the electronic calendar and one or more scheduling targets or constraints associated with one or more calendar users. The orchestration agent may process the calendar action prompt using one or more of the ML models, such as a generative model (e.g., LLM, VLM), to generate calendar action output. The calendar action output may convey one or more actions to be performed in furtherance of managing the electronic calendar to satisfy the one or more scheduling targets or constraints. In particular, one or more of the actions may include triggering a subset of agents (e.g., G2, . . . , Gn) from the plurality of agents G1, G2, . . . , Gn to obtain additional context that can be used during a subsequent iteration of the generative model.

As a working example, suppose a calendar user provides natural language input, e.g., as part of a calendar calibration request or otherwise, that says, “I need to spend more time engaged with superiors and less time engaged with subordinates.” The orchestration agent may assemble this natural language input into a calendar action prompt, e.g., along with data indicative of the electronic calendar (e.g., structured text such as JSON, XML, a database view, etc.) and a request to calibrate the user's calendar accordingly. The orchestration agent may process this calendar action prompt to generate calendar action output. The calendar action output may include instructions (e.g., for an API) that trigger another agent (e.g., G2) with access to an organization's hierarchy (e.g., via a knowledge graph) to retrieve additional context information about the user's position in the hierarchy relative to others. For example, the additional context may take the form of a tree that identifies the position in the hierarchy.

The orchestration agent may then assemble data indicative of this tree into a subsequent calendar action prompt, e.g., along with the user's prior natural language input and data indicative of the electronic calendar. When this updated calendar action prompt is processed using one or more generative models, the next iteration of calendar action output may include, for instance, recommendations to cancel or shorten meetings with subordinates and/or schedule or lengthen meetings with superiors. Additionally or alternatively, the next iteration of calendar action output may include instructions that are executed automatically, e.g., by the calendar application 140 or assistant application 150 (or an underlying operating system), to modify the electronic calendar automatically, without prompting or otherwise interrupting the user (e.g., the user may prefer that calendar changes be implemented automatically).

As another non-limiting example, given a first agent (e.g., G1) selected from the plurality of agents (G1, G2, . . . , Gn), the orchestration agent (e.g., prompt-generating engine 148) can generate a first prompt based on the content of the user input and a first subset of calendar data retrieved for processing using the first agent (e.g., G1). The first prompt can be processed, e.g., by a first ML engine (e.g., the content generation engine 149, or other engine) and using a first ML model (e.g., 191 in FIG. 2A) corresponding to the first ML engine, to generate a first model output (e.g., 207A in FIG. 2A) reflecting first content responsive to the user input. Continuing with the non-limiting example, given a second agent (e.g., G2) selected from the plurality of agents (G1, G2, . . . , Gn), the orchestration agent (e.g., prompt-generating engine 148) can generate a second prompt based on the content of the user input and a second subset of calendar data retrieved for the second agent (e.g., G2). The second prompt can be processed, e.g., by a second ML engine (e.g., the time-tracking engine 147) and using a second ML model corresponding to the second ML engine, to generate a second model output reflecting second content responsive to the user input. Based on the first and second content, the content generation engine 149 can generate a response responsive to the user input. As a non-limiting example, the response can include, for instance, one or more suggestions in natural language that suggest one or more changes to the electronic calendar and/or one or more calendar actions to be performed via the electronic calendar or one or more IoT devices that the calendar application 140 access.

In some implementations, in response to receiving the user input, the calendar rule management engine 144 can retrieve one or more prior calendar rules that are stored in a calendar rule database (e.g., D1 in FIG. 2A) associated with the electronic calendar of the user. The one or more prior calendar rules can be generated based on user input, or can be determined/generated based on detection of pattern(s) in a log of calendar interactions. For example, the one or more prior calendar rule can include a rule such as “block on 1-2pm every Friday for hot yoga”, where such rule is determined/generated based on detection of user activity that repeatedly blocks out the same slot (e.g., 1-2pm) on every Friday for a threshold number of times (e.g., 6 time, 8 times, 20 times, etc.). In some implementations, the user can be notified with a notification (e.g., Do you want to create this—“block on 1-2pm every Friday for hot yoga”—as a new rule?) to receive user confirmation that confirms whether or not to implement the new rule. In some implementations, optionally, the one or more prior calendar rules can include a group rule (company-wise, team-wise, etc.) applicable to a plurality of members within the same group. As a non-limiting example, the group rule can be “no group meeting longer than an hour”, “no meetings on Friday”, “September 5^{th} is a firm holiday and everyone can have the afternoon off”.

In some implementations, the aforementioned first prompt can additionally include the one or more prior calendar rules (e.g., “automatically decline any meeting invite without an agenda”, “never move a one-on-one meeting with VP”). Additionally, or alternatively, the aforementioned second prompt can additionally include the one or more prior calendar rules. In some implementations, optionally, the calendar rule management engine 144 can process the user input to determine one or more calendar rules, and update the calendar rule database by adding the one or more calendar rules determined based on the user input to the calendar rule database, for subsequent use(s).

In some implementations, optionally, the calendar invite management engine 143 can be part of the first agent (e.g., G1 in FIG. 2A). In some implementations, the calendar invite management engine 143 can access a first ML model trained or fine-tuned to process one or more calendar invites and/or metadata associated with the one or more calendar invites, to determine whether to accept or reject one or more of the calendar invites. For example, in response to a first user input of “help me manage my calendar invites and decline unsuitable invite”, the calendar invite management engine 143 can be invoked and retrieve a first subset of calendar data associated with pending calendar invites directed to a user of the first user input (e.g., “help me manage my calendar invites and decline unsuitable invite”). The first subset of calendar data associated with pending calendar invites can include or indicate, for instance, a title (if any) for each pending calendar invite, a meeting note (if any) for each pending calendar invite, one or more attachments (if any, such as an agenda) for each pending calendar invite, a sender of each pending calendar invite, and/or other invitee(s) of each pending calendar invite. In this case, the prompt-generating engine 148 can generate a first prompt based on the content of the first user input and the first subset of calendar data associated with the pending calendar invites for the user. The first prompt can be processed, e.g., using the first ML model accessible by the calendar invite management engine 143, to generate a first model output indicating whether or not to accept or reject each of the pending calendar invites for the user.

For instance, the first model output can indicate a first pending calendar invite is to be rejected. In this case, based on the first model output indicating that the first pending calendar invite is to be rejected, the calendar invite management engine 143 (or the first agent G1) can cause the first pending calendar invites to be automatically rejected. If the first model output additionally, or alternatively, indicate a second pending calendar invite is to be accepted. In this case, based on the first model output indicating that the second pending calendar invite is to be accepted, the calendar invite management engine 143 (or the first agent G1) can cause the second pending calendar invite to be automatically accepted, sending a message to the sender of the second pending calendar invite that the second pending calendar invite is accepted, and/or creating a calendar event for the second pending calendar invite in an electronic calendar (or electronic calendars if there are more than one electronic calendar) of the user.

In some implementations, in response to receiving the first user input (e.g., “help me manage my calendar invites and decline unsuitable invites”), one or more calendar rules (e.g., “decline calendar invites having no specified subject”) can be retrieved from the calendar rule database for the user (e.g., for a user account of the calendar application 140 for the user). In this case, the first prompt (e.g., to be processed as input using the first ML model) can further include the one or more retrieved calendar rules (e.g., “decline calendar invite having no specified subject”). Correspondingly, the aforementioned first pending calendar invite can be rejected based on the first pending calendar invite including no specified subject.

In some implementations, optionally, the calendar calibration engine 145 can be part of the second agent (e.g., G2). In some implementations, the calendar calibration engine 145 can access one or more of the generative models, such as a second ML model trained or fine-tuned to calibrate one or more electronic calendars. For example, in response to a second user input of “help me calibrate my calendar” or “help me calibrate my calendar to shorten group meetings by half”, the calendar calibration engine 145 can be invoked and retrieve a second subset of calendar data (e.g., associated with at least one electronic calendar of the user). The second subset of calendar data associated with the at least one electronic calendar of the user can include or indicate, for instance, a subject (or title) for each upcoming calendar event of the electronic calendar of the user, a note (if any) for each upcoming calendar event, one or more files (if any) associated with each upcoming calendar event, and/or attendee(s) of each upcoming calendar event, etc. In this case, the prompt-generating engine 148 can generate a second prompt based on the content of the second user input and the second subset of calendar data associated with the upcoming calendar event(s). The second prompt can be processed, e.g., using the second ML model accessible by the calendar calibration engine 145, to generate a second model output indicating one or more changes to the electronic calendar of the user (e.g., to one or more calendar events of the electronic calendar). Based on the second model output indicating the one or more changes to the electronic calendar, the calendar calibration engine 145 or the second agent (e.g., G2) can cause the electronic calendar to be calibrated or updated, e.g., by applying the one or more changes to the electronic calendar.

In some implementations, in response to receiving the second user input (e.g., a calendar calibration request of “help me calibrate my calendar to shorten group meetings by half”), one or more calendar rules (e.g., “never modify meetings with a senior manager”) can be retrieved from the calendar rule database for the user. In this case, the aforementioned second prompt (e.g., to be processed as input using the second ML model) can further include the one or more retrieved calendar rules (e.g., “never modify meetings with a senior manager”). Correspondingly, the electronic calendar can be calibrated by modifying the ending time of each upcoming group meeting other than meetings with any senior manager, so that a total length of each upcoming group meeting (other than meetings with any senior manager) is reduced by half.

Optionally, depending on one or more configuration settings of the calendar application 140, the calendar calibration engine 145 can include the calendar invite management engine 143. For example, in some implementations, a pending calendar invite (not yet accepted or declined) can be shown in an electronic calendar as a calendar event (e.g., a temporary calendar event outlined using a dashed line). In this case, a calendar calibration request can, optionally, be directed to not only booked calendar events/items, but also be directed to pending calendar invites (if there is any). But this is not required. In situations where a calendar calibration request is determined as being directed to not only booked calendar events/items but also to pending calendar invites, the first and second ML models can be used to respectively process the particular prompt and the alternative prompt as described above. However, this is not intended to be limiting.

In some implementations, the time-tracking engine 147 can be part of a third agent (e.g., G3). In some implementations, the calendar calibration engine 145 can access one or more of the generative models, such as a third ML model trained or fine-tuned to track time a user (or different users) spends for each calendar event of an electronic calendar of the user (or the different users). Optionally, the third ML model can be further fine-tuned to divide a plurality of calendar events into one or more categories, and track a total amount of time (or percentage of time) the user spends for each category from the one or more categories. For example, in response to a third user input of “How did I spend my time last month”, the time-tracking engine 147 can be invoked and retrieve a third subset of calendar data (e.g., associated with all calendar events of the user within the past month) and/or additional user data (e.g., user activities within other applications such as a social media application, a media player, etc.). In this case, the prompt-generating engine 148 can generate a third prompt based on the content of the third user input (e.g., “How did I spend my time last month”), the third subset of calendar data (e.g., associated with all calendar events of the user within the past month), and/or the additional user data (e.g., user activities within other applications such as a social media application, a media player, etc.). The third prompt can be processed, e.g., using the third ML model accessible by the calendar calibration engine 145, to generate a third model output indicating user statistic data, and a user calendar report can be generated based on the user statistic data.

For example, the user calendar report can include content such as “Over the last month, you spent 38% of your time in heads down work, with 25% scheduled for a specific task and the remaining 13% for personal or non-work needs like social media. You spent 62% of your time in meetings with, 22% of those meetings with people more senior than you and 40% at your level or lower. Want to try and improve senior management visibility more?”

In some implementations, the user calendar report can be generated and/or rendered automatically, without any user input. For instance, a system request for a user calendar report can be automatically generated by the system disclosed herein at the end of each week or month, and the user calendar report can be generated using techniques described herein and in response to receiving the system request. In some implementations, in case the aforementioned third user input is received, one or more calendar rules (e.g., “allow my calendar to access my activities with other apps”) can be retrieved from the calendar rule database for the user. The one or more retrieved calendar rules (e.g., “allow my calendar to access my activities with other apps”) can be included in the aforementioned third prompt, to generate the user calendar report.

In various implementations, the first ML model, the second ML model, and/or the third ML model can each be the same generative model or a distinct generative model. In either case, a given generative model may have less than 100 billion parameters, more than 100 billion parameters, or over 200 billion parameters, etc. The greater the number of parameters of a generative model, the more complex (or sophisticated) a task (e.g., specified in a user query or request) the generative model can handle. The generative model may be stored at the first client computing device 10A (or 10B), or at the server computing device 12. For instance, if the memory of the first client computing device 10A (or 10B) restricts the storing of the generative model at the first client computing device 10A (or 10B) or if a length of a prompt to be processed using the generative model exceeds a predetermined token length, the generative model may be stored at the server device 12. For instance, if the memory of the first client computing device 10A (or 10B) does not restrict the storing of the generative model at the first client computing device 10A, the generative model may be stored at the first client computing device 10A, to reduce a latency in completing a task (e.g., specified in the user query or request), for instance, by avoiding data communications via the one or more networks 13.

In some implementations, when the generative model is stored at the first client computing device 10A, the maximum token length (also referred to as “context length”) of content (e.g., text) processable using the generative mode may be a first maximum token length (e.g., ≤10,000, ≤20,000, ≤50,00, ≤100,000, etc.). In some implementations, when the generative model is stored at the server device 12, the maximum token length of content (e.g., text) processable using the generative model may be a second maximum token length that is greater than the first maximum token length. The maximum token length can be a maximum number of tokens that is allowed for processing, in a single iteration, using the generative model.

Generative models described herein may take various forms, including, but not limited to, model(s) such as Pathways Language Model (PaLM), BERT, Language Model for Dialog Applications (LaMDA), Meena, and/or any other generative model, such as any other generative model that is encoder-only based, decoder-only based, sequence-to-sequence based and that optionally includes an attention mechanism or other memory, diffusion model(s), etc. In some implementations, generative models may include multi-modal models such as a VLM and/or a VQA model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few.

In some implementations, the one or more applications installed at the first client computing device 10A (or 10B) can additionally, or alternatively, include a social media application, a video player, a search application, a note-taking application, a shopping application, a messaging application, and/or any other appropriate applications (or services) installed at, or accessible via, the first client computing device 10A (or 10B).

In various implementations, the server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 10A (or 10B).

In some implementations, the server computing device 12 can further include a training instance generation engine 123. The training instance generation engine 123 can be applied to generate training instances to train (or fine-tune) the aforementioned ML/generative models. A ML model (e.g., a generative model) can be trained or fine-tuned, e.g., via supervised learning and/or using reinforcement learning with human feedback (RLHF) using a reward model).

In various implementations, the assistant application 150 can, additionally, or alternatively, include a plurality of local or cloud-based components. The plurality of local components (or cloud-based components) can include, for instance, an automatic speech recognition (ASR) engine 151, a natural language understanding (NLU) engine 153, a fulfillment engine 155, and/or a text-to-speech (TTS) engine 157 that converts text into audio speech. In some implementations, the ASR engine 151, the NLU engine 153, the fulfillment engine 155, and/or the TTS engine 157 may be, but does not necessarily need to be, included in the assistant application 150. In some implementations, additionally or alternatively, the plurality of local components at the client computing device 10A (or 10B) can include other component(s) such as the agent(s) 142.

In some implementations, the ASR engine 151 (and/or a cloud-based ASR engine) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output (also referred to herein as “transcripts”). The ML model(s) can be on-device ML models that are stored locally at the client computing device 10A, remote ML models that are executed remotely from the server computing device (e.g., at remote server device 12), or shared ML models that are accessible to both the client computing device 10A and/or remote systems (e.g., the remote server computing device 12). The audio data can be acquired from audio recordings or can be generated by microphone(s) of the client computing device 10A (or 10B). Notably, the streaming ASR model can be utilized to generate the corresponding streams of ASR output as the streams of audio data are generated.

In some implementations, the NLU engine 153 can determine semantic meaning(s) of audio and/or text converted by the ASR engine from audio, and decompose the determined semantic meaning(s) to determine intent(s) and/or parameter(s) for an assistant action. For example, the NLU engine 153 can determine an intent and/or parameters for an assistant action based on the aforementioned recognition of the spoken utterance generated by the ASR engine 151.

In some implementations, the fulfillment engine 155 can receive the intent and/or parameter(s) of the intent to fulfill the intent by performing a corresponding assistant action via the assistant application 150. For example, given a single utterance of “what's the weather today in Louisville?”, the fulfillment engine 155 can fulfill the intent (e.g., a search intent) by: (1) causing a search engine to search the Internet using a search parameter of “weather today in Louisville” for an answer/response to the user query of “what's the weather today in Louisville?”, (2) generating fulfillment information (e.g., “it's cloudy outside, with a temperature of 26° C.”), based on a search result (e.g., “Louisville, KY, Monday 11:00 am, cloudy, 26° C.”) of the search, and/or (3) rendering the fulfillment information to the user of the client computing device 10A (or 10B) as the answer (or response).

As another example, given a single utterance of “set the thermostat to 72 F”, the fulfillment engine 155 can receive an intent (e.g., control <device>) and/or parameter(s) (e.g., device name of “thermostat”, temperature of “72 F”) for an assistant action that causes a thermostat to set room temperature at 72 F. In this example, the fulfillment engine 155 can fulfill the intent by generating and forwarding a control signal to the thermostat, where the control signal causes the thermostat to set the room temperature at 72 F.

FIG. 2A schematically illustrates an example of how content or actions may be generated in response to user input directed to a calendar application, using techniques described in accordance with various implementations of the present disclosure. As shown in FIG. 2A, a user may provide a first user input 201 via a client device (e.g., 10A or 10B in FIG. 1). The first user input 201 can be directed to a calendar application (e.g., 140 in FIG. 1). For example, the first user input 201 can be a typed user input (e.g., “Check my working calendar and calendar invites to increase my head-down time for the next two months” or more simply “Check my working calendar to increase my head-down time for the next two months”) received via a user interface of the calendar application. As another example, the first user input 201 can be an audible user input received via an audible user interface via one or more microphones coupled to the client device. The audible user input can be identified as being directed to the calendar application based on one or more hotwords or keywords (e.g., “calendar” and/or “head-down time”).

In some implementations, in response to receiving the first user input 201 in the form of speech that is recorded as a digital audio recording, the ASR engine 151 may generate a transcript 202 and provide that transcript to an orchestration agent such as the agent selection engine 141. The agent selection engine 141 can select a first subset of agents (e.g., a first agent G1 and/or a second agent G2) from a plurality 142 of agents G1, G2, . . . , Gn. As described previously, the plurality 142 of agents G1, G2, . . . , Gn can each include (or access) one or more machine learning (ML) models. For instance, the first agent G1 can include the calendar invite management engine 143 which accesses a first ML model 191 trained (or fine-tuned) to manage calendar invites. The second agent G2 can include the calendar calibration engine 145 which accesses a second ML model 192 (and additional ML models) trained (or fine-tuned) to calibrate (e.g., modify, update, delete, etc.) electronic calendars.

In the non-limiting example where the first user input 201 is typed or audible user input of “Check my working calendar and calendar invites to increase my head-down time for the next two months”, the agent selection engine 141 can select the first agent G1 (or the calendar invite management engine 143) and the second agent G2 (or the calendar calibration engine 145) based on content of the first user input 201 indicating a first user request of performing a first calendar application action (e.g., “Check my working calendar to increase my head-down time for the next two months”) as well as a second user request of performing a second calendar application action (e.g., “Check my calendar invites to increase my head-down time for the next two months”).

Continuing with the non-limiting example above, the first agent G1 (or the calendar invite management engine 143) can select and retrieve a first subset of calendar data 203A associated with pending calendar invites for a user of the first user input 201. The first subset of calendar data 203A can include, for instance, a title (if any) for each pending calendar invite, a meeting note (if any) for each pending calendar invite, one or more attachments (if any, such as an agenda) for each pending calendar invite, a sender of each pending calendar invite, and/or other invitee(s) of each pending calendar invite. The prompt-generating engine 148 can generate a first prompt 205A based on a portion of the content of the first user input (e.g., “Check my calendar invites to increase my head-down time for the next two months”) and the first subset of calendar data 203A. The first prompt 205A can be processed, e.g., using the first ML model 191 accessible by the calendar invite management engine 143, to generate one or more first model output 207A indicating whether or not to accept or reject each of the pending calendar invites for the user.

Continuing with the non-limiting example above, the second agent G2 (or the calendar calibration engine 145) can select and retrieve a second subset of calendar data 203B associated with the working calendar of the user of the first user input 201. The second subset of calendar data 203B can include, for instance, a subject (or title) for each upcoming calendar event of the electronic calendar of the user, a note (if any) for each upcoming calendar event, one or more files (if any) associated with each upcoming calendar event, and/or attendee(s) of each upcoming calendar event, etc. The prompt-generating engine 148 can generate a second prompt 205B based on at least a portion of the content of the first user input 201 (e.g., “Check my working calendar to increase my head-down time for the next two months”) and the second subset of calendar data 203B associated with the upcoming calendar event(s). The second prompt 205B can be processed, e.g., using a second ML model 192 accessible by the calendar calibration engine 145, to generate a second model output 207B indicating one or more changes to the working calendar of the user.

In some implementations, the content generation engine 149 can generate a response 209 (e.g., responsive content) in response to the first user input 201. The responsive content 209 can be based on the first model output 207A and the second model output 207B. For instance, the responsive content 209 can be a message such as “half of your calendar invites are rejected due to sender beyond your working group, and one third of your calendar events within the next two months are reduced in length or canceled, to help achieve your goal of increasing head-down time. Click here to see calendar events that are accepted or rejected, as well as changes made to your working calendar”. In some implementations, based on the second model output 207B indicating the one or more changes to the electronic calendar, the calendar calibration engine 145 or the second agent (e.g., G2) can perform one or more calendar actions. These calendar actions may include, for instance, causing the working calendar to be calibrated or updated by applying one or more changes determined to be applied to the working calendar, e.g., to reject half of the calendar invites determined to be rejected, reduce the length for one or more calendar events by half, cancel one or more calendar events, etc.

In some implementations, optionally, the first prompt 205A can further include a first set of prior calendar rules indicative of scheduling targets and/or constraints associated with user(s) that are stored in a calendar rule database D1. In some implementations, the calendar rule database D1 can be associated with the user of the first user input 201. In some other implementations, the calendar rule database D1 can be associated with a group of different users (e.g., all users within an organization, members of the same family, etc.). In some implementations, optionally, the second prompt 205B can further include a second set of prior calendar rules that are stored in the calendar rule database D1 associated with the user of the first user input 201. In some implementations, optionally, the first user input 201 can be processed to generate a calendar rule. The calendar rule derived from the first user input 201 can be applied to update the calendar rule database D1 associated with the user of the first user input 201. For example, the calendar rule derived from the first user input 201 can be added to the calendar rule database D1. As another example, the calendar rule derived from the first user input 201 can be applied to modify another calendar rule that is stored in the calendar rule database D1.

Referring to FIG. 2B, in some implementations, the user (or a different user) may provide a second user input 211 directed to the calendar application the user has access to. For example, the second user input 211 can be a query (e.g., “Hey Calendar, how did I spend my time last week?”) received via a user interface of the calendar application. The user input can be identified as being directed to the calendar application based on one or more hotwords or keywords (e.g., “calendar”), or based on being received via the graphical user interface of the calendar application.

In some implementations, in response to receiving the second user input 211 as a digital recording of a spoken utterance of the user L, the ASR engine 151 may once again generate a transcript 212 that is once again passed to an orchestration agent such as the agent selection engine 141. The agent selection engine 141 can select a second subset of agents from the plurality 142 of agents G1, G2, . . . , Gn. For example, based on the content of the second user input 211 being “Hey Calendar, how did I spend my time last week?”, the agent selection engine 141 can select the third agent G3 from the plurality 142 of agents G1, G2, . . . , Gn. In this case, the third agent G3 is selected, for instance, based on the content of the second user input 211 indicating a request for time-tracking. The third agent G3 can select and retrieve a third subset of calendar data 203C and/or additional time usage data (e.g., associated with other applications such as social media application, etc.). The third subset of calendar data 203C can include, for instance, starting time and ending time for each calendar event during last week and/or a type for each calendar event during last week.

The prompt-generating engine 148 can generate a third prompt 205C based on the content of the second user input 211 (e.g., “Hey Calendar, how did I spend my time last week?”) and the third subset of calendar data 203C. The third prompt 205C can be processed, e.g., using a third ML model accessible by the calendar calibration engine 145, to generate a third model output 207C reflecting user statistics associated with time spent by the user for different types of user activities (e.g., meetings with senior managers or above, meetings to mentor group members, etc.) during the last week.

In some implementations, the content generation engine 149 can generate a response 213 in response to the second user input 211. The response 213 can be generated based on the third model output 207C, and as a non-limiting example, the response 213 can be, “During the last week, you spent 38% of your time in heads down work, with 25% scheduled for a specific task and the remaining 13% for personal or non-work needs like social media. You spent 62% of your time in meetings with, 22% of those meetings with people more senior than you and 40% at your level or lower. Want to try and improve senior management visibility more?” It is noted that, in some implementations, optionally, the third prompt 205C can further include a third set of prior calendar rules that are stored in a calendar rule database (see, e.g., D1 in FIG. 2A) associated with the user of the second user input 211.

In some implementations, instead of using a plurality of separate ML models 191, 192, . . . , 19n, a single, multi-layer neural network and/or generative model can be applied to the first user input 201 and the second user input 211. The neural network can include a Mixture-of-Experts (MoE) layer having a gating subnetwork and a MoE subnetwork that includes multiple expert models (e.g., each trained or fine-tuned to process a distinct subset of calendar data). Optionally, the neural network can further include a first neural network layer and/or a second neural network layer, where a model output from the first neural network layer can be generated based on processing the first user input 201 (or the second user input 211). The model output from the first neural network layer can be processed as input to the gating subnetwork, to generate a gating subnetwork output indicating a subset of expert models selected from the multiple expert models and/or a gating weight to be assigned to each expert model from the selected subset of expert models. The model output from the first neural network layer can be further processed as input, using the selected subset of expert models, respectively, to generate one or more expert model output.

For example, the gating subnetwork output may indicate that a subset of expert models include a first expert model and a second expert model that are selected from the multiple expert models. The model output from the first neural network layer can be processed as input, using the first expert model, to generate a first expert model output. The model output from the first neural network layer can be processed as input, using the second expert model, to generate a second expert model output. The response 209 (or the response 213) can be generated based on the first expert model output and/or the second expert model output. It is noted that, the descriptions of the MoE-based neural network and application of the MoE-based neural network, however, are not limited herein.

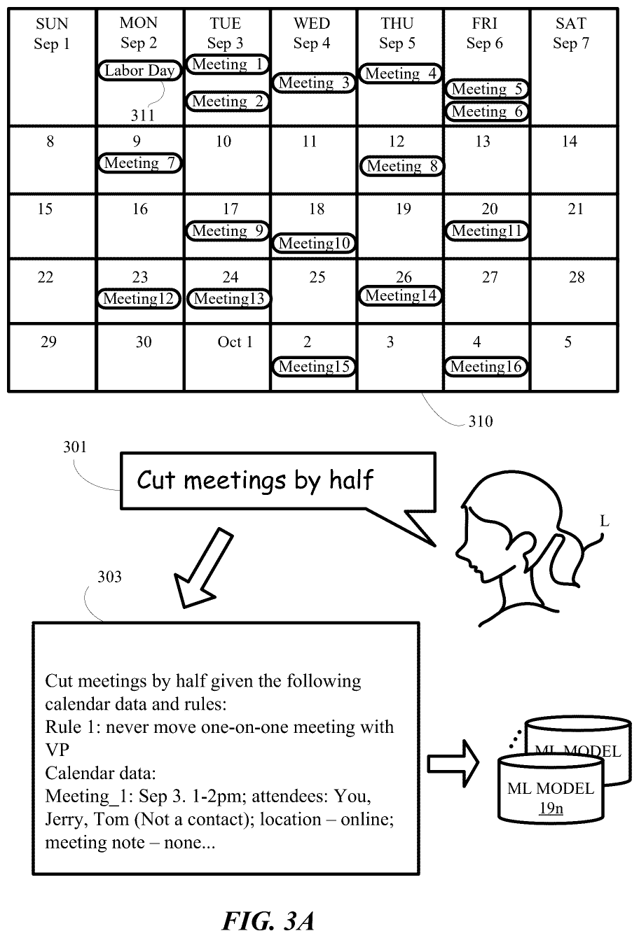

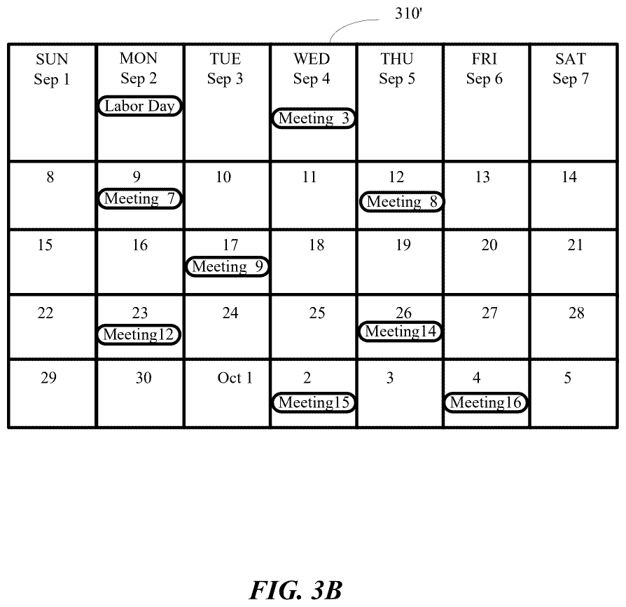

FIG. 3A illustrates a non-limiting example of a prompt generated in response to a user query from a user that is directed to an electronic calendar of the user, in accordance with various implementations of the present disclosure. FIG. 3B illustrates the electronic calendar in FIG. 3A which is calibrated in response to the user query, in accordance with various implementations of the present disclosure. As shown in FIG. 3A, a user (e.g., user L) can provide a user input 301, such as “Cut meetings by half”, to a client device at which an electronic calendar of the user is accessed.

As shown in FIG. 3A, the electronic calendar 310 can include one or more calendar events (sometimes referred to as “calendar entries” or “calendar items”, e.g., 311). The one or more calendar events can include, for instance, a first calendar event (e.g., “Labor day”), a second calendar event (e.g., Meeting 1), a third calendar event (e.g., Meeting 2), . . . , and/or a seventeenth calendar event (e.g., Meeting 16). Each of the one or more calendar events can have different types (e.g., “holiday” vs. “meeting”), different event titles (e.g. “Labor Day” vs. “Meeting 1”), different time slots (e.g., different dates and/or different starting or ending time), different notes or calendar content, different attendees, different attachments, different levels of importance, etc. In some implementations, calendar data associated with each calendar event may be utilized to determine one or more of the above-mentioned aspects (e.g., type, event title, time slot, calendar content, attendee(s), attachment, level of importance, etc.) of a calendar event.

In some implementations, in response to receiving the user input 301, e.g., “Cut meetings by half”, a system can determine that the user input 301 is directed to the electronic calendar 310 of the user. In response to receiving the user input 301 and/or in response to the user input 301 being determined as directed to the electronic calendar 310 of the user, the system can select one or more agents (e.g., calendar agents each accessing a respective ML model trained to process a corresponding type of calendar data) to process calendar data associated with the electronic calendar 310 and the user input 301.

In some implementations, a prompt 303 can be generated based on content of the user input 301 and/or calendar data associated with the electronic calendar 310. In some implementations, instead of including all calendar data associated with the electronic calendar 310, the prompt 303 can include a subset of calendar data (e.g., meeting details for all upcoming calendar events of the type “meeting”, or meeting details of calendar events within a certain temporal period that is specified or indicated in the user input 301) associated with the electronic calendar 310. The subset of calendar data associated with the electronic calendar 310 can be selected, for instance, based on the content (e.g., one or more keywords such as “meetings”) of the user input 301. A non-limiting example of the subset of calendar data associated with the electronic calendar 310 can be found in FIG. 3A, e.g., “Meeting_1: September 3. 1-2pm; attendees: You, Jerry, Tom (Not a contact); location-online; meeting note—none . . . .” Optionally, the prompt 303 can further include one or more prior calendar rules (e.g., “Rule 1: never move one-on-one meeting with VP”, as illustrated in FIG. 3A).

In some implementations, the prompt 303 can be respectively processed as input, using one or more ML models that the selected one or more calendar agents access, to generate one or more model output. Based on the one or more model outputs, responsive content can be generated and/or rendered. Additionally, or alternatively, based on the one or more model outputs, one or more calendar actions can be performed for the electronic calendar 310.

For example, referring to FIG. 3B, the one or more calendar actions (e.g., determined based on processing the prompt 303 using one or more ML models accessible by one or more selected calendar agents) can include selectively keeping half of upcoming meetings (e.g., meetings 3, 7, 8, 9, 12, 14, 15, and 16 being selected from meetings 1˜16) while removing the rest from the electronic calendar 310 based on the user input 301 (e.g., “Cut meetings by half”). It is noted that descriptions of the calendar actions are not limited herein. For example, the one or more calendar actions can include a first calendar action to add a calendar event, a second calendar action to modify (e.g., move, change starting and/or ending time, send additional calendar invite, remove an attendee, add a meeting note, update the level of importance, share a document, etc.), and/or a third calendar action to share a calendar event, etc.

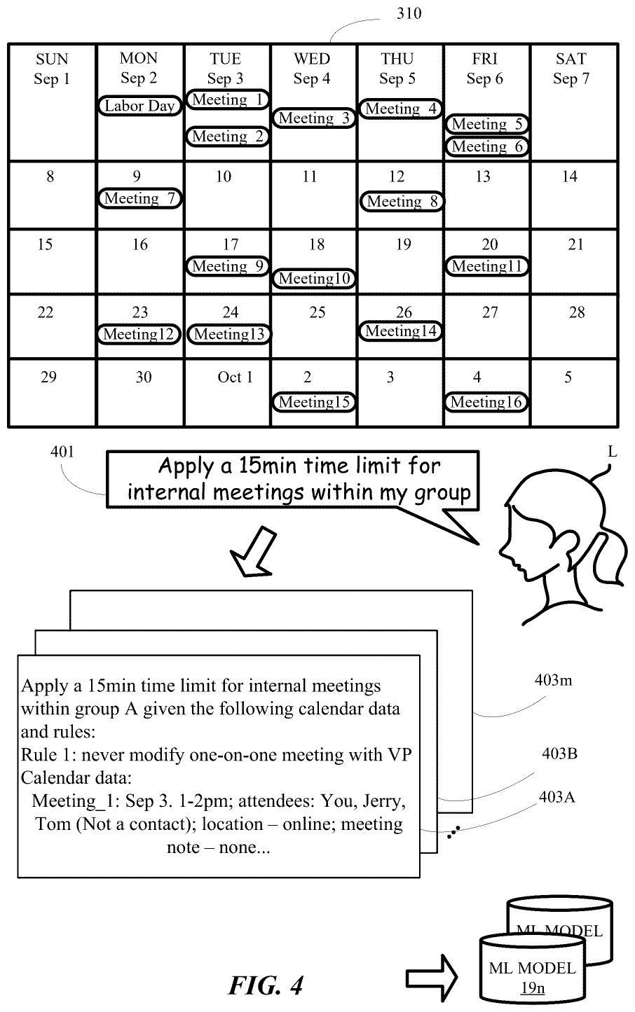

FIG. 4 depicts an example of multiple prompts generated in response to a user query from a user that is directed to multiple electronic calendars associated with users within a group that the user manages, in accordance with various implementations of the present disclosure. As shown in FIG. 4, a user L of an electronic calendar 310 (accessible via the calendar application, e.g., 140 in FIG. 1) may provide an audible user input 401 (or typed user input, etc.) such as “Apply a 15-min time limit for internal meetings within my group” or “Increase heads-down time for my group members”. In response to receiving the user input 401, the system can determine all electronic calendars (e.g., electronic calendar 310 of the user and electronic calendars for users that are managed by the user) associated with members of the group the user manages (or otherwise accesses). In this case, different prompts (e.g., 403A, 403B, . . . , 403m, where “m” is the total number of group members that the user manages) can be generated based on the user input 401 and calendar data associated with the electronic calendars determined in response to receiving the user input 401. For example, the different prompts can include a first prompt 403A, a second prompt 403B, . . . , and an m^{th} prompt 403m.

The first prompt 403A can include the content of the user input 401 (e.g., “Apply a 15 min time limit for internal meetings within group A”) or an instruction containing the user input 401 (e.g., “Apply a 15 min time limit for internal meetings within group A given the following calendar data and rules”). The first prompt 403A can include a prior calendar rule associated with the user (e.g., “Rule 1: never modify one-on-one meeting with VP”). The first prompt 403A can further include calendar data associated with the electronic calendar 310 of the user (or a subset thereof, e.g., calendar data associated with internal meetings from the electronic calendar 310). Content of the second prompt 403B (or other prompt such as 403n) can be different from the first prompt 403A, but can be presented in the same or similar format. For example, the second prompt 403B (while not illustrated in FIG. 4) can include the content of the user input 401 (e.g., “Apply a 15 min time limit for internal meetings within group A”) or an instruction containing the user input 401 (e.g., “Apply a 15 min time limit for internal meetings within group A given the following calendar data and rules”). The second prompt 403B can include a prior calendar rule associated with a first team member that is different from the aforementioned user (e.g., “Rule: reserve Saturday morning for yoga classes”). The second prompt 403B can further include calendar data associated with the electronic calendar 310 of the first team member (or a subset thereof, e.g., calendar data associated with internal meetings from the electronic calendar 310). Descriptions of other prompts (e.g., 403n) are omitted herein for the sake of brevity.

In some implementations, each prompt is generated in association with an electronic calendar for a different user, and different prior calendar rules can be retrieved and/or included in different prompts. In some implementations, content of the subset of calendar data associated with different electronic calendars can be different from each other, and be correspondingly included in the different prompts. In some implementations, each of the different prompts can be processed using a corresponding set of ML model(s) to generate responsive content and/or to perform a corresponding calendar action automatically. For example, given the user input 401 (e.g., “Apply a 15 min time limit for internal meetings within my group”), a first group of internal meetings in the electronic calendar 310 of the user can be modified to each have a time limit of fifteen minutes, and a second group of internal meetings in a different electronic calendar of a different user can be modified each having a time limit of fifteen minutes, where the first group of internal meetings can be different from the second group of internal meetings (e.g., by including at least one different internal meeting).

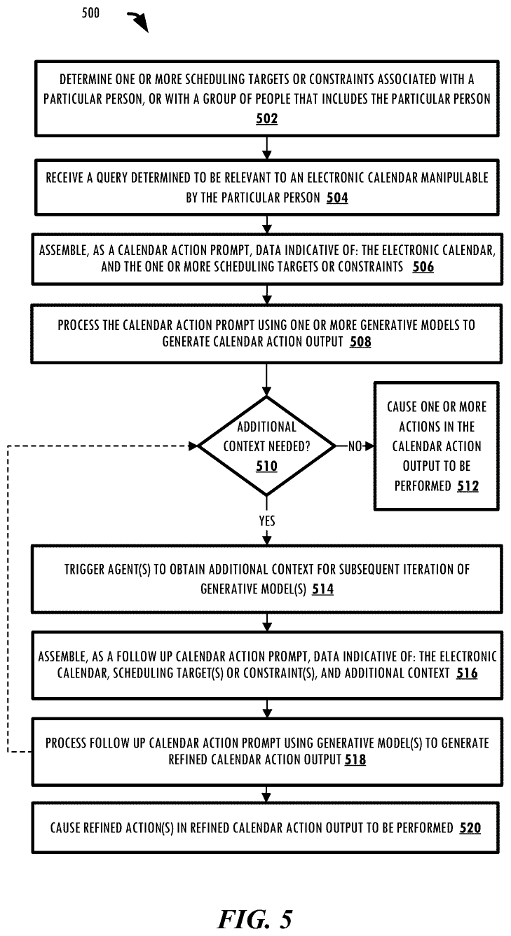

Referring now to FIG. 5, an example method 500 of practicing selected aspects of the present disclosure to summarize robot execution traces is described. For convenience, the operations of the flowchart are described with reference to a system that performs the operations. This system may include various components of various computer systems. Moreover, while operations of method 500 are shown in a particular order, this is not meant to be limiting. One or more operations may be reordered, omitted or added.

At block 502, the system, e.g., by way of calendar rule management engine 144, may determine one or more scheduling targets or constraints associated with a particular person, or with a group of people that includes the particular person. These scheduling targets or constraints may be determined in real time, e.g., when a relevant query is received at block 504, or offline, e.g., by soliciting them from users and/or detecting patterns in calendar interaction log(s). The scheduling targets and/or constraints may be expressed and/or persistent in memory in various forms, such as in a natural language representation of the one or more scheduling targets or constraints. In some implementations, a scheduling target or constraint may be determined from an explicit natural language input received by the particular person, e.g., as part of a calendar calibration request.

Additionally or alternatively, in some implementations, a scheduling target or constraint may be determined from an explicit natural language input received by another member of a group or organization of people other than the particular person. For example, someone from upper management may issue a proclamation that there be no meetings on Fridays, and/or that no employee should have more than three hours of meetings per day.

It is also not required that scheduling targets or constraints be stated explicitly. For example, in some implementations, a scheduling target or constraint may be determined automatically and/or offline, e.g., based on pattern(s) of interaction detected in a log of calendar interactions with the electronic calendar. For example, if a particular user tends to reject calendar invites on Friday afternoons, then a scheduling constraint may be created for that particular user such as “I don't do meetings on Friday afternoons.” That scheduling constraint may be included in subsequent input prompts generated in relation to that particular user.

Referring back to FIG. 5, at block 504, the system, e.g., by way of user input engine 101, may receive a query determined to be relevant to an electronic calendar manipulable by the particular person. For example, the query (or a transcript thereof if originally spoken) may include a keyword such as “calendar” or “schedule.” The electronic calendar may be used exclusively by the particular person, or may be shared by a group of people that includes the particular person. As used herein, an electronic calendar is “manipulable” by a person if that person has the right to modify, cancel, move, or otherwise alter aspects of the electronic calendar, such as individual calendar entries/items.

At block 506, the system, e.g., by way of an orchestration agent such as agent selection engine 141, prompt generation engine 148, and/or calendar data selection engine 146, may assemble, as a calendar action prompt, data indicative of: the electronic calendar and the one or more scheduling targets or constraints. Non-limiting examples of calendar action prompts were depicted at 303 and 403.

At block 508, the system, e.g., by way of content generation engine 149, may process the calendar action prompt using one or more generative models to generate calendar action output. In various implementations, the calendar action output may convey one or more actions to be performed in furtherance of managing the electronic calendar to satisfy the one or more scheduling targets or constraints. These actions can include, for instance, generating a recommendation to modify one or more entries of the electronic calendar, causing the recommendation to be rendered at one or more output devices, canceling or rescheduling one or more entries of the electronic calendar, determining whether to accept or reject a calendar invite, etc. In some implementations, the one or more actions may include determining whether to create preparation or follow up calendar entry for the electronic calendar. The preparation or follow up calendar entry may be scheduled to occur before or after another calendar entry of the electronic calendar that involves the particular person and one or more other participants. For example, if an upcoming calendar entry involves a superior at an organization, an earlier calendar entry may be proposed or automatically created to allow for preparation for that meeting.

At block 510, the system may determine whether additional context is needed to perform one or more of the actions, and/or whether one or more of the actions itself includes triggering an agent to obtain additional context. For example, the calendar action output generated using the generative model may include instructions (e.g., in natural language, an API call, etc.) to trigger a particular agent to obtain information about an organization's hierarchy. This may be a consequence of, for instance, the query including a request that is reliant on such a hierarchy, such as “I need to increase facetime with higher ups and reduce meetings with subordinates” (which would require additional context to determine which people are “higher ups” relative to the particular person and which are subordinate to the particular person).

If the answer at block 510 is no, then method 500 may proceed to block 512. At block 512, the system may cause one or more of the actions contained in the calendar action output to be performed. However, if the answer at block 510 is yes (additional context needed), then method 500 may proceed to block 514.

At block 514, the system, e.g., by way of agent selection engine 141, may trigger one or more agents (e.g., G1, G2, . . . ) to obtain additional context for a subsequent iteration of one or more of the generative models. For example, the agent may retrieve data indicative of a corporate hierarchy. At block 516, the system, e.g., by way of prompt generation engine 145 and/or the triggered agent(s), may assemble, as a follow up calendar action prompt, data indicative of: the electronic calendar, the one or more scheduling targets or constraints, and the additional context.

At block 518, the system, e.g., by way of the agent and/or content generation engine 149, may process the follow up calendar action prompt using one or more of the generative models to generate refined calendar action output. In various implementations, the refined calendar action output may convey additional refined actions to be performed in furtherance of managing the electronic calendar to satisfy the one or more scheduling targets or constraints. As indicated by the dashed arrow, in some implementations, method 500 may optionally proceed back to block 510 to determine whether additional context is needed, and blocks 514-518 may be repeated if necessary. At block 520, the system may cause one or more of the refined/additional actions to be performed.

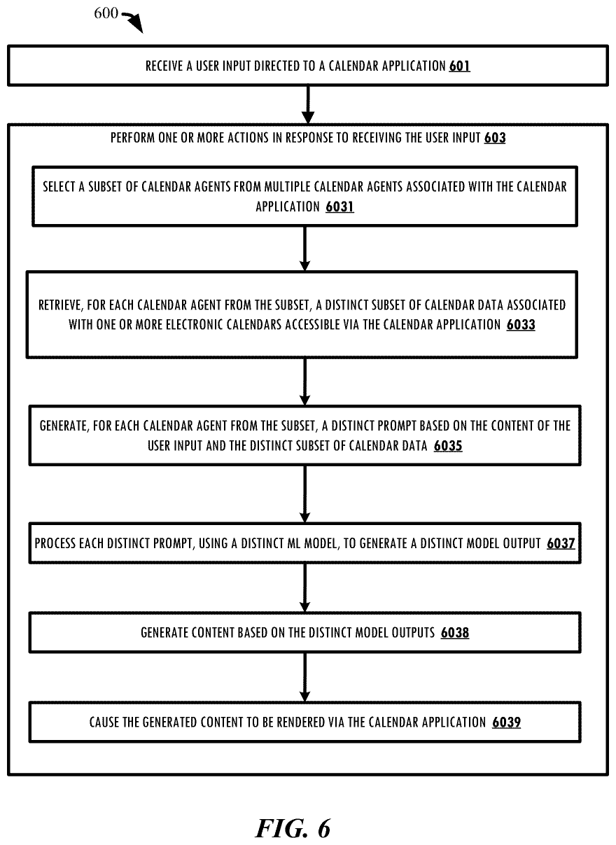

Turning now to FIG. 6, a flowchart illustrating a method of calibrating one or more electronic calendars is provided, in accordance with various aspects of the present disclosure. A system for performing the method 600 includes one or more processors, memory, and/or other component(s) of computing device(s) (e.g., the first client computing device 10A of FIG. 1, one or more servers such as the server computing device 12, and/or other computing devices). Moreover, while operations of the method 600 are shown in a particular order, this is not meant to be limiting. One or more operations may be reordered, omitted, and/or added.

In various implementations, at block 601, the system, e.g., by way of user input engine 101, may receive, from a user and via a client device (e.g., 10A, 10B) of the user, a user input directed to a calendar application 140 accessible at the client device.

At block 603, the system, e.g., by way of calendar application 140 or assistant application 150, may perform one or more actions in response to receiving the user input directed to the calendar application. The one or more actions may include, for instance, selecting a subset of calendar agents from a plurality of calendar agents associated with the calendar application (block 6031). Additionally, the one or more actions can include: retrieving, for each calendar agent from the selected subset, a distinct subset of calendar data associated with one or more electronic calendars that the user accesses via the calendar application (block 6033). Additionally, the one or more actions can include: generating, for each calendar agents from the selected subset, a distinct prompt based on the content of the user input and the distinct subset of calendar data (block 6035).

Additionally, the one or more actions can include: causing each agent to process each distinct prompt, using a distinct machine learning model and by a respective calendar agent from the selected subset that accesses the distinct machine learning model, to generate a distinct model output (block 6037). Additionally, the one or more actions can include: generating content based on the distinct model outputs generated based on processing each distinct prompt (block 6038). Additionally, the one or more actions can include: causing the generated content to be rendered via the calendar application (block 6039).

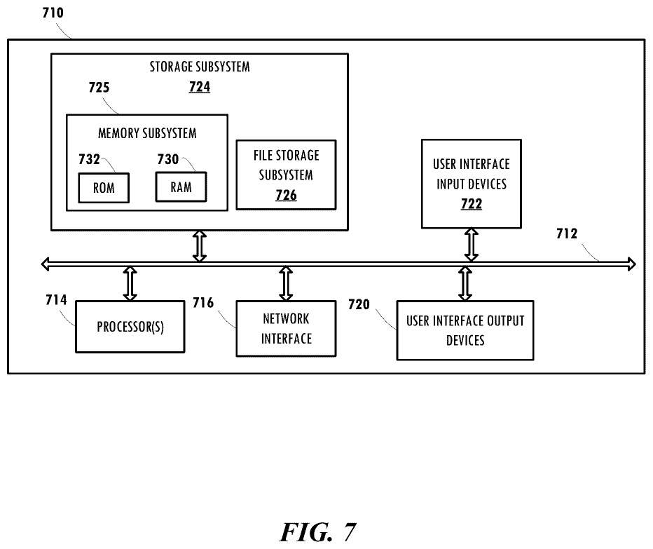

Turning now to FIG. 7, a block diagram of an example computing device 710 that may optionally be utilized to perform one or more aspects of techniques described herein is depicted. In some implementations, one or more of a client device, cloud-based LLM-based assistant component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIG. 1.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

For example, in various implementations, a method may be implemented using one or more processors and may include determining scheduling targets or constraints for a person. Upon receiving a relevant query, a calendar action prompt may be assembled based on the calendar and scheduling targets. Generative model(s) may then be used to process these prompt(s) and generate actions that may help manage the calendar to meet those targets or constraints. Finally, these actions may be executed.

In various implementations, the scheduling targets or constraints may be represented in natural language. In various implementations, actions may include generating recommendations to modify calendar entries and displaying them on output devices. In various implementations, actions may include canceling or rescheduling calendar entries. In various implementations, actions may include deciding whether to accept or reject calendar invites.

In various implementations, actions may include deciding whether to create preparation or follow-up calendar entries before or after other related entries. In various implementations, scheduling targets or constraints may be determined from explicit natural language input from the person. In various implementations, scheduling targets or constraints may be determined from explicit natural language input from others in the group. In various implementations, scheduling targets or constraints may be determined based on patterns detected in calendar interaction logs. In various implementations, the calendar may be manipulable by multiple people in the group.

In various implementations, the generative models may be trained or fine-tuned using calendar interaction logs. In various implementations, actions may include triggering agents to obtain additional context, assembling a follow-up prompt, processing it with generative models to generate refined output, and executing the refined actions. In various implementations, the additional context may include relationships between the person and others in the group. In various implementations, the additional context may include the person's position in a hierarchical organization. In various implementations, agents may be configured to obtain additional context by submitting search queries to a search engine. In various implementations, agents may be configured to obtain additional context from a knowledge graph. In various implementations, agents may obtain additional context by prompting one or more of the generative models to generate contextual output.

In a related aspect, a method may be implemented using one or more processors may include: receiving, from a user and via a client device of the user, a user input directed to a calendar application accessible at the client device; in response to receiving the user input directed to the calendar application: determining that the user input includes a request to calibrate multiple electronic calendars accessible via the calendar application, wherein the multiple electronic calendars are associated with different users, for each of the multiple electronic calendars: selecting a subset of machine learning models from a plurality of machine learning models associated with the calendar application, retrieving, for each machine learning model from the subset of machine learning models, a distinct subset of calendar data associated with a respective electronic calendar from the multiple electronic calendars, generating, for each machine learning model from the subset of machine learning models, a distinct prompt based on the content of the user input and the distinct subset of calendar data, processing each distinct prompt, using a corresponding machine learning model from the subset of machine learning models, to generate a distinct model output, and determining responsive content or a calendar action based on the distinct model outputs respectively generated based on processing each distinct prompt.

In various implementations, the subset of machine learning models may include a first machine learning model and a second machine learning model different from the first machine learning model. In various implementations, retrieving, for each machine learning model from the subset of machine learning models, the distinct subset of calendar data associated with the respective electronic calendar from the multiple electronic calendars may include: retrieving a first subset of calendar data for the first machine learning model, and retrieving a second subset of calendar data for the second machine learning model, wherein the first subset of calendar data is different from the second subset of calendar data.

1. A method implemented using one or more processors, the method comprising:
determining one or more scheduling targets or constraints associated with a particular person, or with a group of people that includes the particular person;
in response to receiving a query determined to be relevant to an electronic calendar manipulable by the particular person:
assembling, by an orchestration agent, as a calendar action prompt, data indicative of:
the electronic calendar formatted as a structured text representation, and
the one or more scheduling targets or constraints;
processing the calendar action prompt using one or more generative models, wherein the one or more generative models comprise a large language model (LLM), to generate calendar action output comprising instructions for an API to be executed by the one or more of the processors, wherein the calendar action output conveys one or more actions to be performed in furtherance of managing the electronic calendar to satisfy the one or more scheduling targets or constraints; and
automatically executing, by one or more of the processors, the instructions for the API to cause one or more of the actions to be performed.

2. The method of claim 1, wherein the data indicative of the one or more scheduling targets or constraints comprises a natural language representation of the one or more scheduling targets or constraints.

3. The method of claim 1, wherein the one or more actions comprise:
generating a recommendation to modify one or more entries of the electronic calendar; and
causing the recommendation to be rendered at one or more output devices.

4. The method of claim 1, wherein the one or more actions comprise canceling or rescheduling one or more entries of the electronic calendar.

5. The method of claim 1, wherein the one or more actions comprise determining whether to accept or reject a calendar invite.

6. The method of claim 1, wherein the one or more actions comprise determining whether to create preparation or follow up calendar entry for the electronic calendar, wherein the preparation or follow up calendar entry occurs before or after another calendar entry of the electronic calendar that involves the particular person and one or more other participants.

7. The method of claim 1, wherein one or more of the scheduling targets or constraints is determined from an explicit natural language input received by the particular person.

8. The method of claim 1, wherein one or more of the scheduling targets or constraints is determined from an explicit natural language input received by one or more of the group of people other than the particular person.

9. The method of claim 1, wherein one or more of the scheduling targets or constraints is determined based on one or more patterns of interaction detected in a log of calendar interactions with the electronic calendar.

10. The method of claim 9, wherein the electronic calendar is manipulable by one or more additional people of the group of people.

11. The method of claim 1, further comprising training or finetuning one or more of the generative models based on a log of calendar interactions with the electronic calendar.

12. The method of claim 1, wherein the one or more actions comprise:
triggering one or more agents to obtain additional context for a subsequent iteration of one or more of the generative models;
assembling, as a follow up calendar action prompt, data indicative of:
the electronic calendar,
the one or more scheduling targets or constraints, and
the additional context;
processing the follow up calendar action prompt using one or more of the generative models to generate refined calendar action output, wherein the refined calendar action output conveys one or more additional actions to be performed in furtherance of managing the electronic calendar to satisfy the one or more scheduling targets or constraints; and
causing one or more of the additional actions to be performed.

13. The method of claim 12, wherein the additional context comprises one or more relationships of the particular person with one or more other people of the group of people.

14. The method of claim 12, wherein the additional context comprises a position of the particular person in a hierarchical organization.

15. The method of claim 12, wherein one or more of the agents is configured to obtain additional context by submitting a search query to a search engine.

16. The method of claim 12, wherein one or more of the agents is configured to obtain additional context from a knowledge graph.

17. The method of claim 12, wherein one or more of the agents obtains additional context by prompting one or more of the generative models to generate contextual output, wherein the contextual output comprises the additional context.

18. A method implemented using one or more processors, the method comprising:
receiving, from a user and via a client device of the user, a user input directed to a calendar application accessible at the client device;
in response to receiving the user input directed to the calendar application, based on content of the user input:
selecting, by an agent selection engine, a subset of machine learning models from a plurality of machine learning models associated with the calendar application,
retrieving, for each machine learning model from the subset of machine learning models, a distinct subset of calendar data associated with an electronic calendar that the user accesses via the calendar application,
generating, for each machine learning model from the subset of machine learning models, a distinct prompt based on the content of the user input and the distinct subset of calendar data,
processing each distinct prompt, using a corresponding machine learning model from the subset of machine learning models, to generate a distinct model output comprising instructions for an API to be executed by the one or more of the processors,
generating content based on the distinct model outputs respectively generated based on processing each distinct prompt, and
automatically executing, by one or more of the processors, the instructions for the API to cause the generated content to be rendered via the calendar application.

19. The method of claim 1, wherein the user input includes a first request to manage one or more pending calendar invites, and the subset of machine learning models includes a first machine learning model trained to determine whether to accept or reject calendar invites; and
wherein retrieving, for each machine learning model from the subset of machine learning models, the distinct subset of calendar data comprises retrieving a first subset of calendar data associated with the one or more pending calendar invites.

20. A method implemented using one or more processors, the method comprising:
receiving, from a user and via a client device of the user, a user input directed to a calendar application accessible at the client device;
in response to receiving the user input directed to the calendar application:
selecting by an agent selection engine a subset of machine learning models from a plurality of machine learning models associated with the calendar application,
retrieving, for each machine learning model from the subset of machine learning models, a distinct subset of calendar data associated with an electronic calendar that the user accesses via the calendar application,
generating, for each machine learning model from the subset of machine learning models, a distinct prompt based on the content of the user input and the distinct subset of calendar data,
processing each distinct prompt, using a corresponding machine learning model from the subset of machine learning models, to generate a distinct model output comprising instructions for an API to be executed by the one or more of the processors,
determining one or more calendar actions based on the distinct model outputs respectively generated based on processing each distinct prompt, and
automatically executing, by one or more of the processors, the instructions for the API to cause the one or more calendar actions to be performed automatically by the calendar application.
